(19) United States
(12) Patent Application Publication
(10) Pub. No.: US 2004/0184096 A1
(43) Pub. Date: Sep. 23, 2004

(54) Legacy fax service system in home network and method thereof

(75) Inventor: Moon-jeong Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/772,466

(22) Filed: Feb. 6, 2004

(30) Foreign Application Priority Data
Feb. 6, 2003 (KR) 10-2003-0007592

(51) Int. Cl. H04N 1/32; G06F 1/32; G06F 3/00; G06F 15/00; H04M 11/00

(52) U.S. Cl. 358/1.15; 358/468; 379/100.06; 710/19; 713/310

(57) ABSTRACT

Disclosed is a fax service system in a home network. When the fax data destined for the fax machine connected to the home network through a power switch and a telephone line, is received from an external network through the Internet Protocol, the fax service system stores the received fax data in the storage means, and detects power on/off states of the fax machine through a middleware server which collects and controls device information and control information from information devices connected to the home network. If the fax machine is detected to be in an off state from the middleware server, the fax service system switches the fax machine into a power on state through the middleware server, and transmits the stored fax data to the fax machine. Since a user can be immediately informed of the receipt of the fax data, power consumption can be saved.

### CROSS-REFERENCE TO RELATED APPLICATIONS

This application claims the benefit of Korean Application No. 2003-7592, filed Feb. 6, 2003, in the Korean Intellectual Property Office, the disclosure of which is incorporated herein by reference.

### BACKGROUND

11. Field of the Invention

Apparatuses and methods consistent with the present invention relate to a fax data processing system and a method for processing a fax data received through the Internet protocol, and the method of processing the same, and more particularly, to a fax service system in a home network and a method thereof.

2. Description of the Related Art

As the technology of communications developed, the Internet appeared as a way of integrally connecting communicating terminals around the world with a huge single network. Further, a variety of information electronic appliances, which are additionally provided with networking function, have been provided, such as an Internet refrigerator for networking at home, a digital TV and a set-top box.

FIG. 1 is a drawing showing a general home-network structure comprising a telephone line, a wireless LAN or a Bluetooth network, a USB network, an IEEE 1394 network and a power line network.

telephone 120a, a notebook computer 120b, a fax machine 120c and a computer 120d are connected to a telephone line 1120.

To the wireless LAN or the Bluetooth network 1130, a notebook computer 130a and a PDA 130b are connected.

To the USB network 1140, a computer 140a, a printer 140b and a scanner 140c are connected.

To the IEEE 1394 network 1150 which is a communication protocol for A/V devices, a television 150a, a camcorder 150b and an audio system 150c are connected.

To a power line 1160, a fax machine (facsimile A), a coffee maker 160a, an electric rice cooker 160b, a refrigerator 160c, and a washing machine 160d are connected.

A gateway 110 in the home network provides a path connecting the devices in the sub-networks 1120, 1130, 1140, 1150, and 1160 to the external networks. These sub-networks 1120, 1130, 1140, 1150, and 1160 are connected to each other by connection devices 170 such as a bridge.

However, since the conventional home-network 100 uses existing networks such as the telephone line and the power line together with new networks such as a Bluetooth network and a wireless LAN, and these devices are operated in different hardware and software platforms, it is not easy for the devices to communicate each other using a single system.

Accordingly, as a method to solve the above problem, a middleware is suggested to establish a common virtual computing environment for the domestic devices in the scattered networks, and also to provide an application program.

The middleware is located between an operating system and an application program and connects the scattered application and data in the client server environment. Further, the middleware supports various communication protocols, system structures, operating systems, databases and application programs.

Meanwhile, Voice over Internet Protocol (VoIP) technology has been introduced to transmit audio information in digital packets using the Internet Protocol instead of transmitting audio signals to a conventional Public Switched Telephone Network (PSTN).

VoIP enables voice communication through the Internet by compressing an audio signal into the G.711, G729A, G723.1 standards and then transmitting the audio signal from one H.323 gateway to another H.323 gateway. VoIP additionally uses Real Time Protocol (RTP) to support a timely arrival of packets. Moreover, it is very easy to encrypt audio data using the Internet Protocol since the audio data is transmitted in the same way as general data. For instance, a Virtual Private Network (VPN) encrypts the voice communication into data incomprehensible to a wiretap.

A main advantage of such Internet telephone technology using VoIP is that telephone users can be offered long-distance telephone call service and international telephone call service in the Internet and the Intranet by combining telephone services using the conventional IP network.

Further, Fax over IP (FoIP) has been introduced, which is technically similar to VoIP, for transmitting fax data through a packet network such as the IP network instead of PSTN. Transmitting fax data in a packet form enables general fax machines to be connectively operated with each other through packet network. FoIP extracts a fax image from an analog signal to transmit in digital data form through a packet network. Using the IP network, fax data can be transmitted to the e-mail address, and further, a document file can be directly transmitted from a PC to a fax machine without being printed.

The International Telecommunication Union (ITU) and the Internet Engineering Task Force (IETF) have cooperated to develop a real time transmission system (T.38) and store-and-forward transmission system (T.37) into the FoIP network standard. T.37 and T.38 were approved by the ITU in June, 1998. In particular, T.38 is a fax transmission protocol for H.323.

As a gateway for supporting T.38, which is the fax standard protocol, has been developed recently, it is getting more competitive to offer FoIP service which provides a fax service with a voice service in a package form through a VoIP network.

Meanwhile, customers demand relatively cheap services and devices, and accordingly, services have been improved in widespread home network. However, the conventional gateway for supporting T.38 still focuses on a function of transmitting the conventional fax service through the Internet. Therefore, more various services are desired.

Further, the gateway for supporting T.38 can not transmit data any more when the conventional legacy fax machine is off. Therefore, if a user is not aware that the fax machine is off by mistake, the user would submit himself to loss of unreceived fax data.

### SUMMARY

It is an aspect of the present invention to provide a legacy fax service system in a home network and method thereof, in order to offer a fax service regardless of an on/off state of the fax machine, immediately inform a user whether a fax data is received, and even save power of the legacy fax machine.

Another aspect of the present invention is to provide a fax service processing device to achieve the above aspect.

A legacy fax service system in a home network, according to the present invention, comprises a middleware server for collecting a device information and a control information from at least one information device, and providing the device information and the control information upon request a storage means for storing the fax data received from outside, a legacy fax machine connected to the home network through a power switch and a telephone line, and a fax data processing unit, upon receiving a fax data destined for the legacy fax machine from an external network through an Internet Protocol, for storing the received fax data in the storage means, and the fax data processing unit transmits a control command to the power switch through the middleware server to switch the legacy fax machine into on state when the legacy fax machine is detected as being in off state according to the information from the middleware server, and then transmits the stored fax data to the legacy fax machine through the telephone line.

The fax data processing unit requests the middleware server to display a message informing a receipt of the fax data on a display which is connected to the home network, when the fax data is received from the external network. For the display, a television connected to the home network, and other means for displaying can be used. Additionally, the fax data processing unit can show the message by controlling the power supply for the display when the display is in the off state. Alternatively, when the display is in the off state, the fax data processing unit can search the power state of a second display and a third display through the middleware server, and then show the message through a display which is in on state.

In addition, the fax data processing unit transmits a control command to the power switch through the middleware server to switch the legacy fax machine into power off state when the fax data is completely transmitted to the legacy fax machine. The power switch may be a power line communication in the legacy fax machine, or an adaptor which connects a power plug of the legacy fax machine with a jack for supplying power to the legacy fax machine, and switches the power supply according to the control command.

A method of the fax service in a home network according to the present invention comprises the steps of providing an identifier (ID) respectively to a variety of information devices connected to the home network and collecting a device information and a control information from each information device, receiving a fax data through the Internet Protocol destined for the legacy fax machine, which is connected to the home network through the power switch and a telephone line, from an external network, and storing the received fax data in the storage means, transmitting a control command to power switch through the middleware server to switch the legacy fax machine into the on state when the off state of the legacy fax machine is detected from the collected information, and transmitting the stored fax data to the legacy fax machine through the telephone line when the legacy fax machine is switched into the on state.

The method of the fax service in the home network further comprises the step of displaying a message informing a receipt of the fax data on a display which is connected to the home network, when the fax data is received from the external network.

In addition, the method of the fax service in the home network further comprises the step of transmitting a control command to the power switch through the middleware server to switch the power supply of the legacy fax machine into the off state.

A fax service processing apparatus to achieve another aspect of the present invention comprises a first interface operating in order that information devices which are connected to an external network and the home network are connectively operated with each other, collecting a device information and a control information from at least one information device, and then exchanging a fax data through the Internet Protocol with a home gateway which has a middleware server for providing the device information and the control information upon request, a second interface connected with a legacy fax machine through a power switch and a telephone line to exchange the fax data, a storage means for storing the fax data received through the first interface, and a control unit for receiving a fax data through the first interface, storing the received fax data in the storage means, transmitting a control command to the power switch through the middleware server to switch the legacy fax machine into on state when the legacy fax machine is detected as being in off state according to the information from the middleware server, and outputting the stored fax data to the legacy fax machine through the second interface.

The control unit requests the middleware server to display a message informing a receipt of the fax data on a display which is connected to the home network, when the fax data is received from the external network.

In addition, after the fax data is completely transmitted to the legacy fax machine, the control unit transmits a control command to the power switch through the middleware server to switch the power supply of the legacy fax machine into power off state.

According to the exemplary embodiment of the present invention, a fax service processing apparatus, system and a method thereof can offer an FoIP service targeting the legacy fax machine, immediately inform a user whether a fax data is received, and save power of the legacy fax machine since it is driven only when a fax data is received.

### BRIEF DESCRIPTION OF THE DRAWINGS

These and other features, aspects, and advantages of the present invention will become better understood with regard to the following description, appended claims, and accompanying drawings where:

FIG. 1 is a block diagram showing a structure of a general conventional home network;

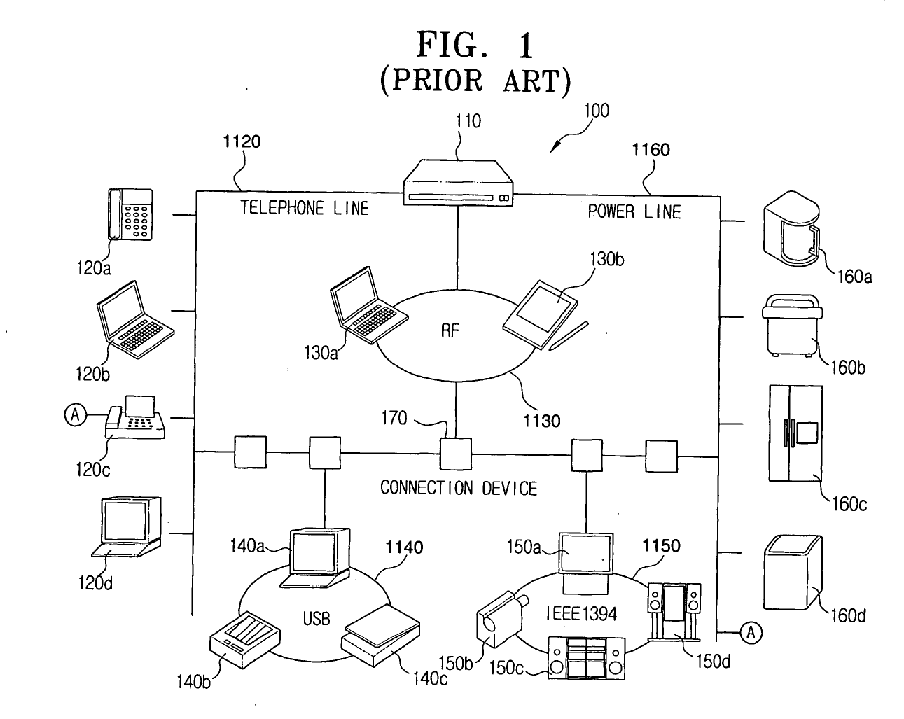

FIG. 2 is a block diagram showing a home network including a legacy fax service system, according to an exemplary embodiment of the present invention;

FIG. 3 is a block diagram of the fax gateway of FIG. 2;

FIG. 4 is a drawing showing a structure of the adaptor of FIG. 2;

FIG. 5 is a flowchart illustrating the operation of the fax gateway of FIG. 2; and

FIG. 6 is a flowchart illustrating a signal flow of an operation in a home network having a home gateway mounted with an FoIP gateway module, in which the fax gateway of FIG. 2 is modularized, and a legacy fax machine having a power line communication (PLC) module.

### DESCRIPTION OF THE EXEMPLARY EMBODIMENTS

Hereinafter, an exemplary embodiment of a legacy fax service system in a home network and method thereof will be described in great detail with reference to the accompanying drawings.

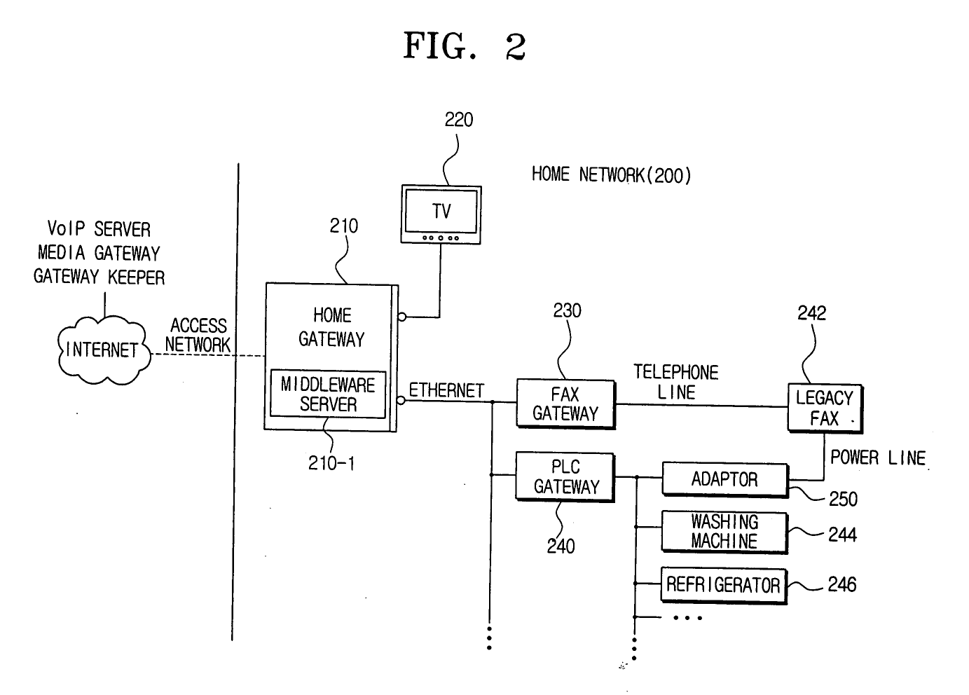

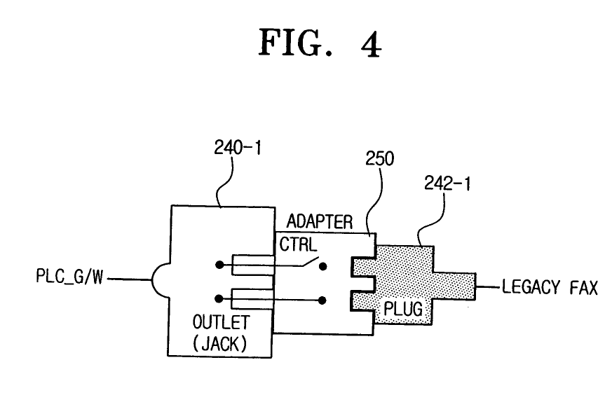

FIG. 2 is a drawing of the network having a legacy fax service system in the home network, according to an embodiment of the present invention. The fax service system comprises a home gateway 210, a display 220, a fax gateway 230, a PLC gateway 240, a power switch and a legacy fax machine 242. Other devices such as a washing machine 244 and a refrigerator 246 are connected to the PLC gateway 240 by a power line. Meanwhile, as an example of the power switch, an adaptor 250 is used in FIGS. 2 and 4.

The home gateway 210 operates in order that the various information devices 220, 230, 240, 250, 242, 244, 246 connected to an external network such as the Internet and the home network are connectively operated with each other, and comprises a middleware server 210-1 which provides an identifier (ID) respectively to the information devices connected to the home network 200, collects a device information and a control information from each information device, and provides the device information and the control information according to information request.

The display 220 can be a television, for example, which is connected to the home network 200. Besides, other displaying devices capable of displaying a message can be used for the display 220. Upon request by the middleware server 210-1 of the home gateway 210, the display 220 displays a message informing of a receipt of a requested fax data.

The fax gateway 230 transmits the fax data using an Internet Protocol from the home gateway 210 to the legacy fax machine 242.

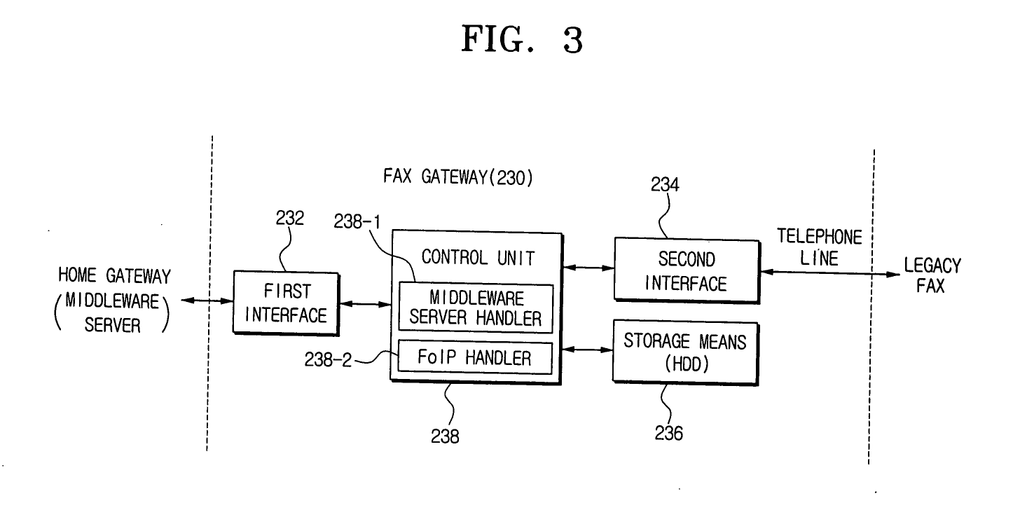

FIG. 3 is a block diagram of a fax gateway 230 according to the present invention. The fax gateway 230 comprises a first interface 232, a second interface 234, a storage means 236, and a control unit 238.

The first interface 232 exchanges the fax data with the home gateway 210 through the Internet Protocol.

The second interface 234 is connected with the legacy fax machine 242 through a telephone line and the power switch, and exchanges the fax data with the legacy fax machine 242.

The storage means 236 stores the fax data received through the first interface 232. A Hard Disk Drive (HDD), other storage media, and other memories can be the storage means 236.

The control unit 238 comprises a middleware server handler 238-1 for communicating with the middleware server 210-1 implemented in the home gateway 210, and an FoIP handler 238-2 for processing the fax data received through the first interface 232.

The PLC gateway 240 communicates with the home gateway 210, and collects and controls information on the devices 242, 244, 246, 250 connected to the power line in the home network 200.

On the other hand, the power switch turns on/off the legacy fax machine by the control command. FIG. 2 shows an example in which the adaptor 250 is used for the power switch.

The adaptor 250 connects a power plug 242-1 of the legacy fax machine 242 and a jack 240-1 for supplying power to the legacy fax machine 242, and controls power supply according to a control command. FIG. 4 shows a structure of the adaptor 250 for connecting the power plug 242-1 of the legacy fax machine 242 and the jack 240-1 for supplying power to the legacy fax machine 242. In FIG. 4, the adaptor 250 is in off state.

Meanwhile, in another embodiment of the present invention, a PLC module mounted in the legacy fax machine 242 can serve as the power switch on behalf of the adaptor 250.

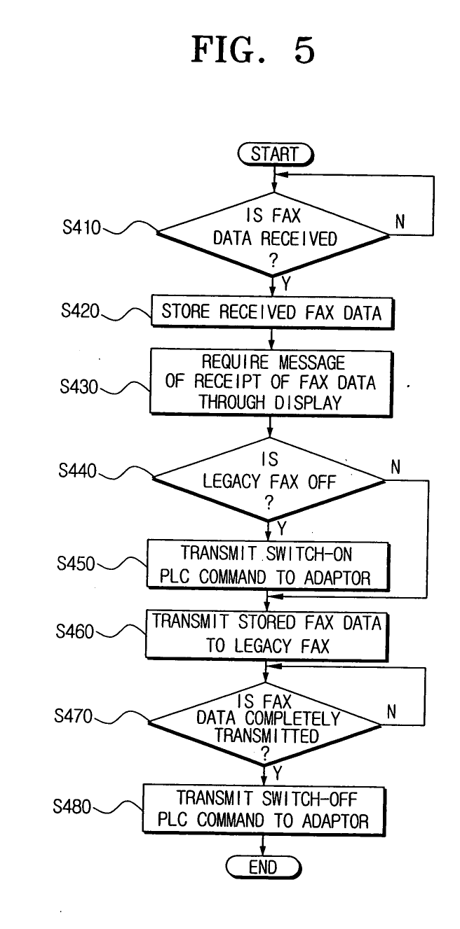

FIG. 5 is a flowchart illustrating the operation of the fax gateway 230 in the home network of FIG. 2. In the fax gateway 230, when fax data is received through the first interface 232 (S410), the FoIP handler 238-2 stores the fax data in the storage means 236 (S420). On the other hand, the middleware server handler 238-1 requires the middleware server 238 mounted in the home gateway 210 to display a message informing a receipt of the fax data on the display 220 (S430). The middleware server handler 238-1 checks the on/off state of the legacy fax machine 242 based on information from the middleware server 210-1 of the home gateway 210 (S440). If the legacy fax machine is detected as off state, the middleware server handler 238-1 transmits a switch-on command to the adaptor 250 of the legacy fax machine 242 through the middleware server 210-1 to switch the legacy fax machine 242 into on state (S450). When the legacy fax machine 242 is detected as having been switched to on state, the FoIP handler 238-2 outputs the fax data stored in the storage means 236 to the legacy fax machine 242 through the second interface 234 (S460). If the fax data transmission is completed (S470), the FoIP handler 210-1 transmits a signal of fax data transmission completion to the middleware server handler 238-1, and thereby the middleware server handler 238-1 transmits a switch-off command to the adaptor 250 connected to the PLC gateway 240 through the middleware server 210-1 of the home gateway 210 in order not to supply power any longer. Accordingly, no more power is supplied to the legacy fax machine 242.

With the above fax service system in the home network, a user can be informed of a receipt of a fax data through the display 220. Furthermore, the above fax service system enables power-saving of the legacy fax machine 242 by driving the fax machine only upon receiving a fax data.

Meanwhile, in the fax service system in the home network of FIG. 2, the function of the fax gateway 230 and/or the PLC gateway 240 can be respectively modularized and mounted in the home gateway 210. Moreover, the adaptor 250 can be replaced with the PLC module mounted in the legacy fax machine 242.

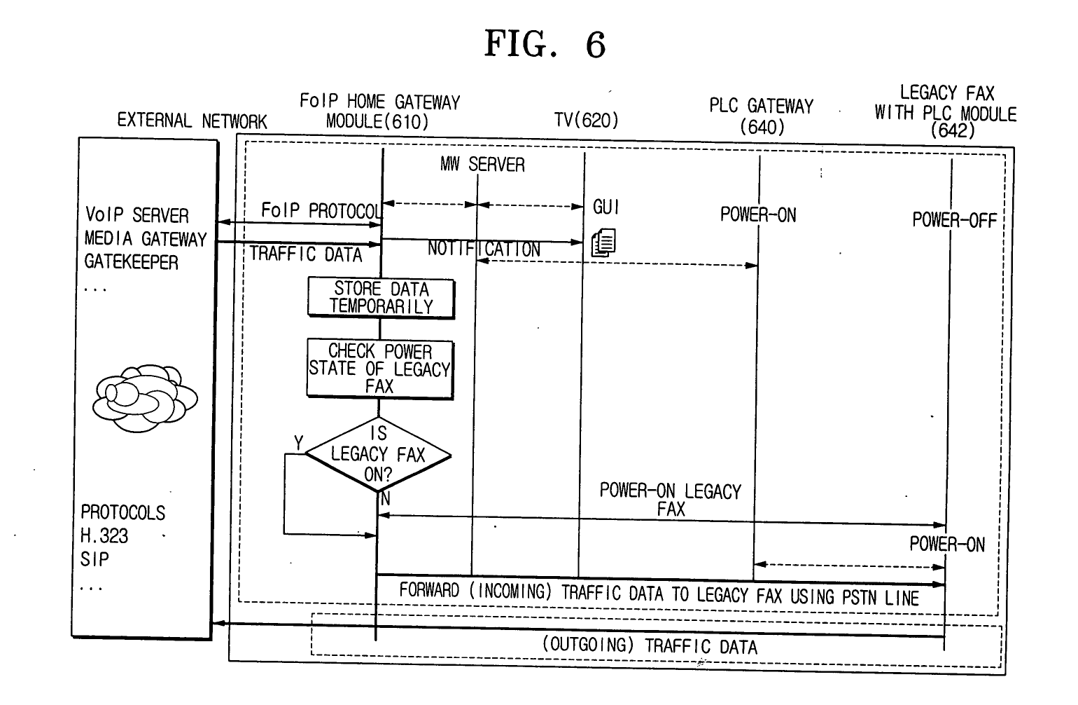

FIG. 6 is a flowchart illustrating a signal flow of an operation in a home network having a home gateway 610 mounted with an FoIP gateway module, in which the fax gateway of FIG. 2 is modularized, and a legacy fax machine having a PLC module. The service processing operation in FIG. 6 is similar to the fax service processing operation in FIG. 5. However, the operation in FIG. 6 is controlled by the PLC module, not by the adaptor 250 as in FIG. 5.

Further, instead of mounting the storage means 236 of the fax gateway 230 of FIG. 3 inside the home gateway and the fax gateway, another device having a storing function can be adopted.

That is, the components of the embodiment of the present invention may be integrally provided as one device, or may be provided being divided into several devices.

The legacy fax service system in the home network and the method thereof can offer an FoIP service targeting the legacy fax machine, and immediately inform a user whether a fax data is received, and therefore, prevent a loss caused due to a missing fax data.

Moreover, the legacy fax service system can save power since the legacy fax machine is driven only when fax data is received.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fax service system in a home network comprising:
a middleware server for collecting a device information and a control information from at least one information device connected to the home network, and providing the device information and the control information upon a request;
a storage means for storing a fax data;
a fax machine connected to the home network through a power switch and a telephone line; and
a fax data processing unit receiving the fax data through the Internet Protocol destined for the fax machine which is connected to the home network through the power switch and the telephone line, and storing the fax data in the storage means, wherein
the fax data processing unit transmits a control command to the power switch through the middleware server to change the fax machine into an on state when the fax machine is detected as being in an off state according to an information of the fax machine from the middleware server, and then transmits the fax data to the fax machine through the telephone line.

2. The fax service system in the home network of claim 1, wherein the fax data processing unit requests the middleware server to display a message informing a receipt of the fax data on a display connected to the home network, when the fax data is received from an external network.

3. The fax service system in the home network of claim 1, wherein the fax data processing unit transmits a control command to the power switch through the middleware server to change the fax machine into the off state when the fax data is completely transmitted to the fax machine.

4. The fax service system in the home network of claim 3, wherein the power switch is a power line communication module in the fax machine.

5. The fax service system in the home network of claim 1, wherein the power switch is an adaptor which connects a power plug of the fax machine with a jack for controlling a supply of power to the fax machine to change a fax machine state comprising the on state and the off state, according to the control command.

6. A method of a fax service in a home network comprising the steps of:
providing a respective identifier (ID) to each of information devices connected to the home network and collecting a respective device information and a respective control information from each of the information devices as collected information;
receiving a fax data through the Internet Protocol destined for a fax machine connected to the home network through a power switch and a telephone line, and storing the fax data in a storage means;
transmitting a control command to the power switch of the fax machine through a middleware server to change the fax machine into an on state when an off state of the fax machine is detected from the collected information; and
transmitting the fax data to the fax machine through the telephone line when the fax machine is changed into the on state.

7. The method of the fax service in the home network of claim 6, further comprising the step of displaying a message informing a receipt of the fax data on a display which is connected to the home network, when the fax data is received from an external network.

8. The method of the fax service in the home network of claim 7, further comprising the step of transmitting a control command to the power switch through the middleware server to change the fax machine into the off state.

9. The method of the fax service in the home network of claim 8, wherein the power switch is a power line communication module in the fax machine.

10. The method of the fax service in the home network of claim 8, wherein the power switch is an adaptor which connects a power plug of the fax machine with a jack for controlling a supply of power to the fax machine to change a fax machine state comprising the on state and the off state, according to the control command.

11. A fax service processing apparatus in a home network, comprising:
a first interface operating in order that information devices which are connected to an external network and the home network are connectively operated with each other, collecting a respective device information and a respective control information from at least one information device, and then exchanging a fax data through the Internet Protocol with a home gateway which has a middleware server for providing the respective device information and the respective control information upon request;
a second interface connected with a fax machine through a power switch and a telephone line to exchange the fax data;
a storage means for storing the fax data received through the first interface; and
a control unit for receiving the fax data through the first interface, storing the fax data in the storage means, transmitting a control command to the power switch through the middleware server to change the fax machine into an on state when the fax machine is detected as being in an off state according to an information of the fax machine from the middleware server, and outputting the fax data to the fax machine through the second interface.

12. The fax service processing apparatus of claim 11, wherein the control unit requests the middleware server to display a message informing a receipt of the fax data on a display which is connected to the home network, when the fax data is received from the external network.

13. The fax service processing apparatus of claim 12, wherein the control unit transmits a control command to the power switch through the middleware server to switch the fax machine into the off state.

14. The fax service processing apparatus of claim 13, wherein the power switch is a power line communication module in the fax machine.

15. The fax service processing apparatus of claim 13, wherein the power switch is an adaptor which connects a power plug of the fax machine with a jack for supplying power to the fax machine, and switches the power supply according to the control command.

16. The fax service system in the home network of claim 1, wherein the fax data processing unit receives the fax data from an external network.

17. The method of fax service in the home network of claim 6, wherein the fax data is received from an external network.
